(19) United States
(12) Patent Application Publication
(10) Pub. No.: US 2011/0148644 A1
(43) Pub. Date: Jun. 23, 2011

(54) Visual Alert Timing Device

(76) Inventor: Raymond Giustiniani, Saint Augustine, FL (US)

(21) Appl. No.: 12/640,500

(22) Filed: Dec. 17, 2009

(51) Int. Cl. G08B 21/00

(52) U.S. Cl. 340/635

(57) ABSTRACT

I have invented an improvement to a basic timer device that allows for a visual alert mode and pray that Letters Patent may be granted for the improvement idea for a visual alert timer, as set forth in the patent application specification which uses electrical power, however the device can be powered by any source and can function as both an auditory and/or a visual alert device. I invented this idea to improve the timer on 20 Feb. 1989 as an assistive device for the Deaf; however this improvement idea can be used to aid any individual needing a visual alert while working in a noisy work environment at home or in the workplace.

I have invented an improvement to a basic timer device that allows for a visual alert mode and pray that Letters Patent may be granted for the improvement idea for a visual alert timer, as set forth in the following specification which uses electrical power, however the device can be powered by any source and can function as both an auditory and/or a visual alert device. I invented this idea to improve the timer on 20 Feb. 1989 as an assistive device for the Deaf; however this improvement idea can be used to aid any individual needing a visual alert while working in a noisy work environment at home or in the workplace.

### DESCRIPTION OF THE DRAWINGS

FIG. 1 is a front elevation of my idea which changes the basic timer to a visual alert device;

FIG. 2 is a top plan view of my idea which changes the basic timer to a visual alert device;

FIG. 3 is a bottom plan of my idea which changes the basic timer to a visual alert device;

FIG. 4 is a left side elevation of my idea which changes the basic timer to a visual alert device;

FIG. 5 is a right side elevation of my idea which changes the basic timer to a visual alert device;

FIG. 6 is a rear elevation of my idea which changes the basic timer to a visual alert device;

FIG. 7a is an interior view of my idea to change the timer to a visual alerting device using a two-way relay with wiring to activate the visual alert.

FIG. 7b is an interior view depicting the timer dial with my idea to change the timer to a visual alerting device using a two-way relay with wiring to activate the visual alert.

FIG. 8a is an illustration of the modified basic timer showing the electric functionality of the visual alerting device where A1 and A2 are the on/off light indicators, B1 and B2 are the electrical sockets to plug in a lamp or other visual alerting light such as a light bulb, C is the on/off switch for activating the visual alert mode, D is the electrical plug to plug into the electrical power source and E is the two-way relay used to change the alert from the bell to the light.

FIG. 8b is a depiction of the visual alert wiring and relay implemented to modify the basic timer to prove it can operate as a visual alert timer where A1 and A2 are the on/off light indicators, B1 and B2 are the electrical sockets to plug in a lamp or other visual alerting light such as a light bulb, C is the on/off switch for activating the visual alert mode, D is the electrical plug to plug into the electrical power source and E is the two-way relay used to change the alert from the bell to the light.

FIG. 9 is an illustration of how the device can be made to operate with both auditory and visual alerts functioning independently or together alerting both with the bell (auditory alert) and with the light (visual alert) and will later file a design patent for the same.

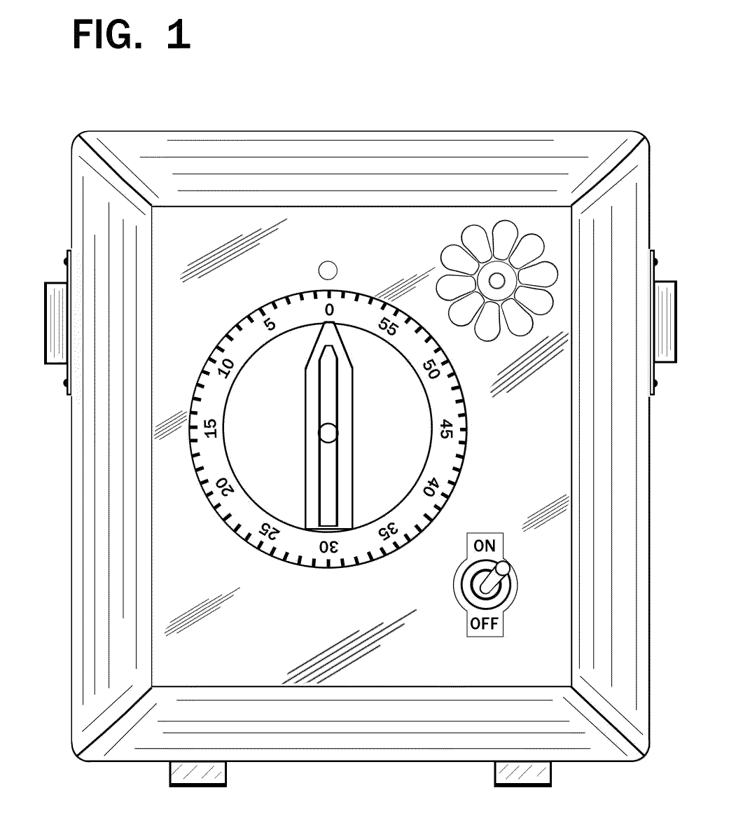

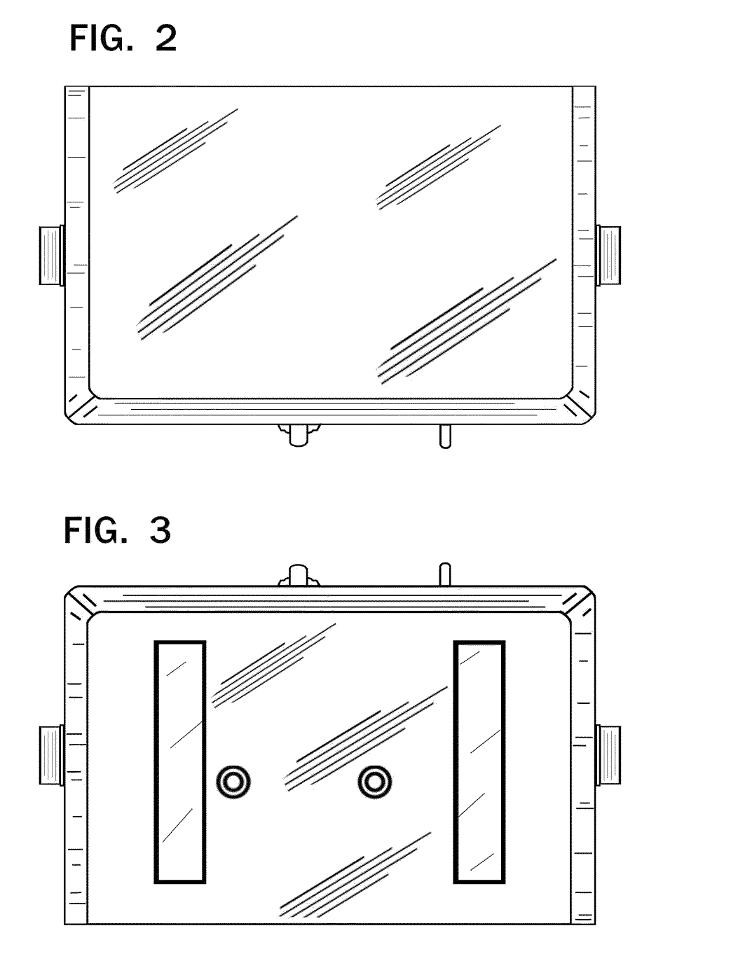

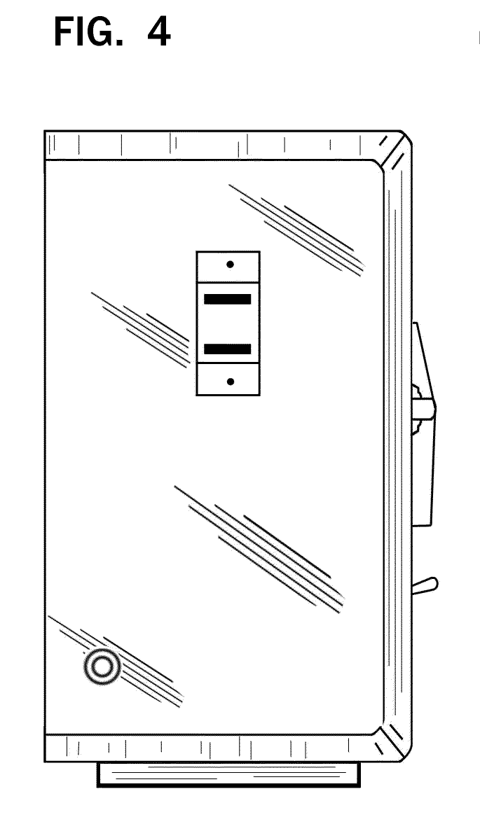

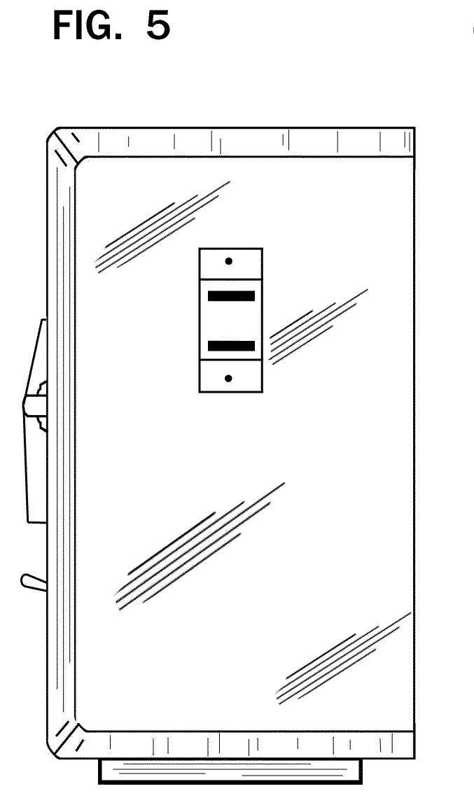

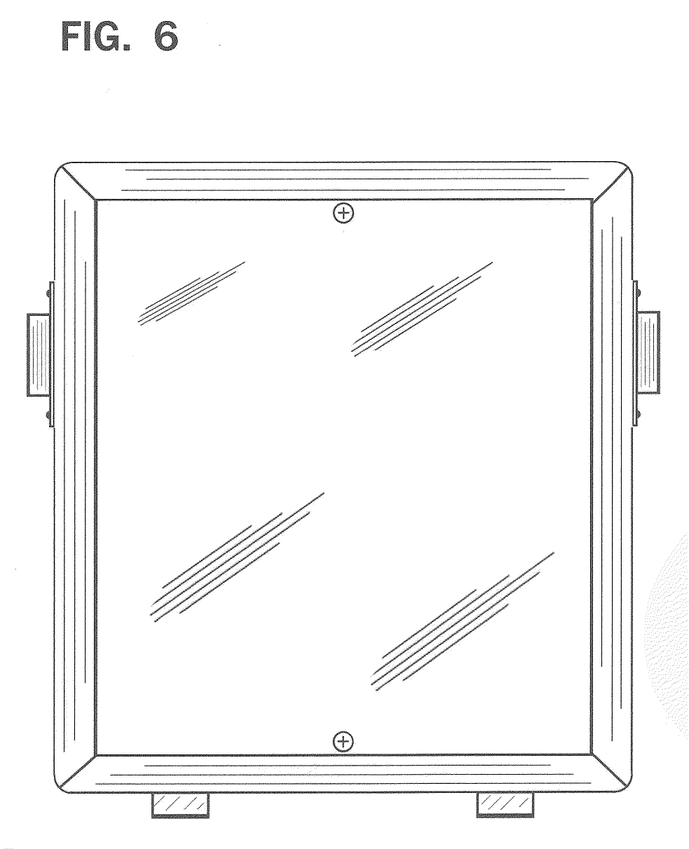

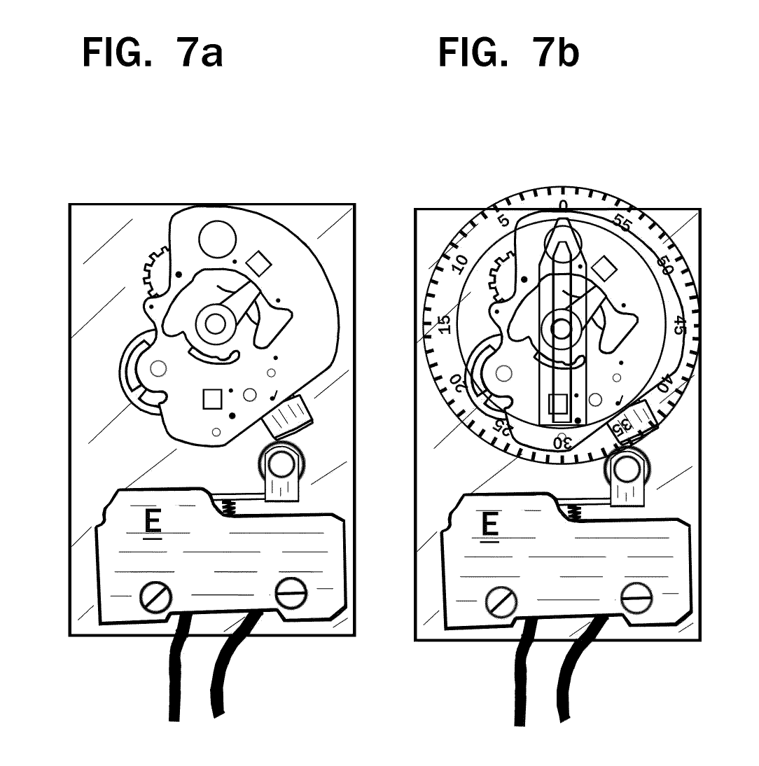

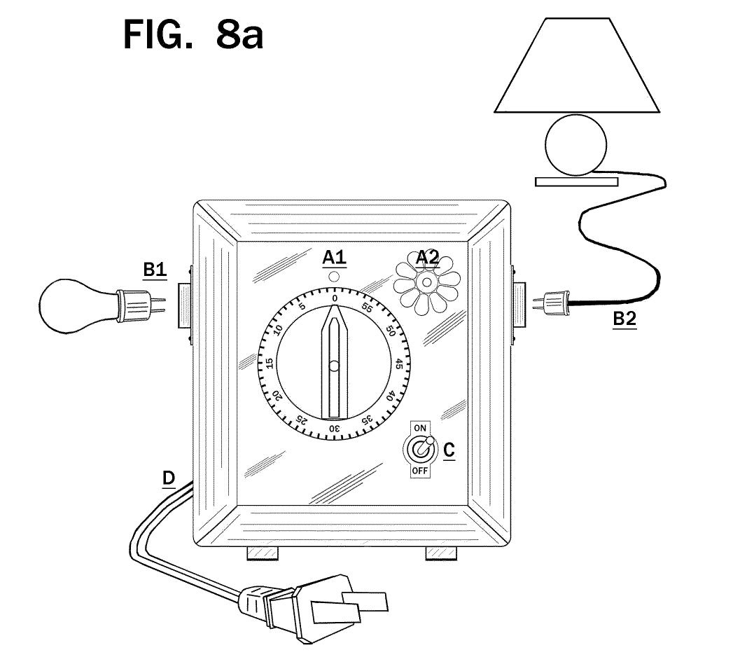

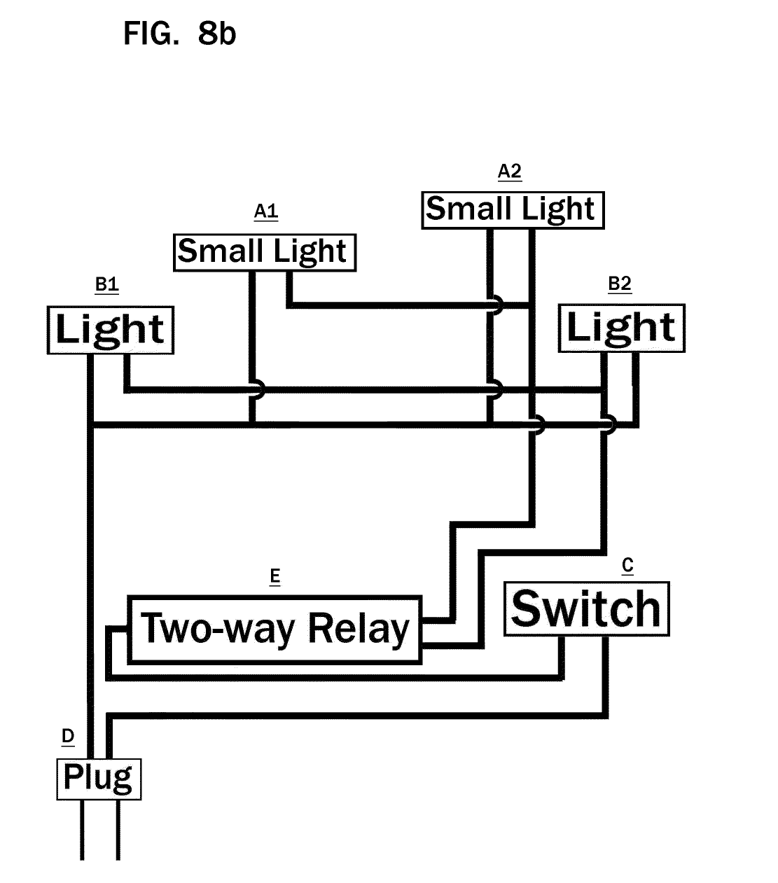

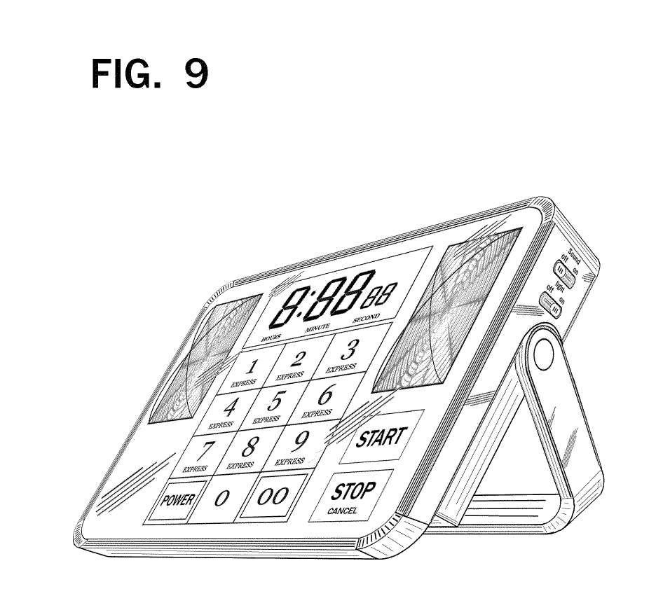

The environment of the claimed invention drawings to modify the basic timer to include my visual alert idea is shown in broken lines for illustrative purposes only as the claim is for my idea to improve the functionality of the basic timer to a multi alerting device.

The idea to add a change to a basic timer to allow for a visual alert, as shown and described.

I claim:

1: The environment of the claimed invention drawings to modify the basic timer to include my visual alert idea is shown in broken lines for illustrative purposes only as the claim is for my idea to improve the functionality of the basic timer to a multi alerting device, in particular to add a visual alert function.
